(19) United States
(12) Patent Application Publication
(10) Pub. No.: US 2012/0195417 A1
(43) Pub. Date: Aug. 2, 2012

(54) METHOD OF USING FLEXIBLE DISPLAY NAMES IN INTERNET PROTOCOL MULTIMEDIA SUBSYSTEM NETWORKS

(76) Inventors: SUZANN HUA, Lisle, IL (US); Ahmed Zaki, Lisle, IL (US)

(21) Appl. No.: 13/017,297

(22) Filed: Jan. 31, 2011

(51) Int. Cl. H04M 15/06

(52) U.S. Cl. 379/142.04

(57) ABSTRACT

The present invention provides a method for supporting flexible display names in a communication network. One embodiment of the method includes selecting, at a network entity, one of a plurality of display names for a calling party in response to receiving a request to initiate a call from the calling party to a called party. This embodiment of the method also includes transmitting a message from the network entity towards the called party. The message includes the selected display name for the calling party.

### BACKGROUND OF THE INVENTION

1. Field of the Invention

This invention relates generally to communication systems, and, more particularly, to using flexible display names in communication systems.

2. Description of the Related Art

The Internet Protocol (IP) Multimedia Subsystem (IMS) is an architectural framework for delivering IP multimedia services over wired and/or wireless networks. The IMS framework was originally designed by the 3rd Generation Partnership Project (3GPP) wireless standards body as a part of the vision for evolving mobile networks beyond the Global System for Mobile communication (GSM). The IMS standards and protocols are defined to aid the access of multimedia and voice applications from wireless and wireline terminals to support a form of fixed-mobile convergence (FMC). The original formulation of the IMS framework (3GPP R5) represented an approach to delivering services over General Packet Radio Service (GPRS) networks. Subsequent formulations have been updated by 3GPP, 3GPP2 and other standards bodies such as Telecommunications and Internet converged Services and Protocols for Advanced Networking (TISPAN) to support other networks such as Wireless LAN, CDMA2000 and fixed line networks.

Users of, or subscribers to, an IMS network are identified using a unique permanently allocated global private identity and one or more public user identifiers (PUIDs). Each PUID can be used by any user for requesting communications to other users (e.g., the PUID can be included on a business card). A single public identifier can also be shared between multiple phones or terminals so that each device associated with the public user identifier can be reached with the same PUID. For example, a single phone-number could be used to call an entire family or organization. Each user or subscriber also has a user profile or IMS service profile, which may be stored on a home subscriber server or user profile server function in the IMS network. Current standards for the IMS network allow an IMS subscriber's PUID to have a single display name stored as part of subscriber's IMS service profile. The display name of a calling party can be displayed to a called party to identify the calling party to the called party. However, the current IMS standard stipulates that one and only one display name can be supported for each IMS subscriber's PUID. Consequently, the display name conveys the same information to every called party.

### SUMMARY OF EMBODIMENTS OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for supporting flexible display names in a communication network. One embodiment of the method includes selecting, at a network entity, one of a plurality of display names for a calling party in response to receiving a request to initiate a call from the calling party to a called party. This embodiment of the method also includes transmitting a message from the network entity towards the called party. The message includes the selected display name for the calling party.

In another embodiment, a method is provided for supporting flexible display names. One embodiment of the method includes storing at least one subscriber profile at a home subscriber server. Each subscriber profile includes a plurality of display names for a subscriber associated with the subscriber profile and each of the plurality of display names can be transmitted to a called party when a subscriber initiates a call to the called party. This embodiment of the method also includes transmitting the selected subscriber profile from the home subscriber server to a network entity in response to the subscriber registering with the network entity.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates a first exemplary embodiment of a communication system;

FIG. 2 conceptually illustrates a second exemplary embodiment of a communication system;

FIG. 3 conceptually illustrates one exemplary embodiment of a subscriber profile; and

FIG. 4 conceptually illustrates one exemplary embodiment of a method of selecting one of a plurality of display names.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

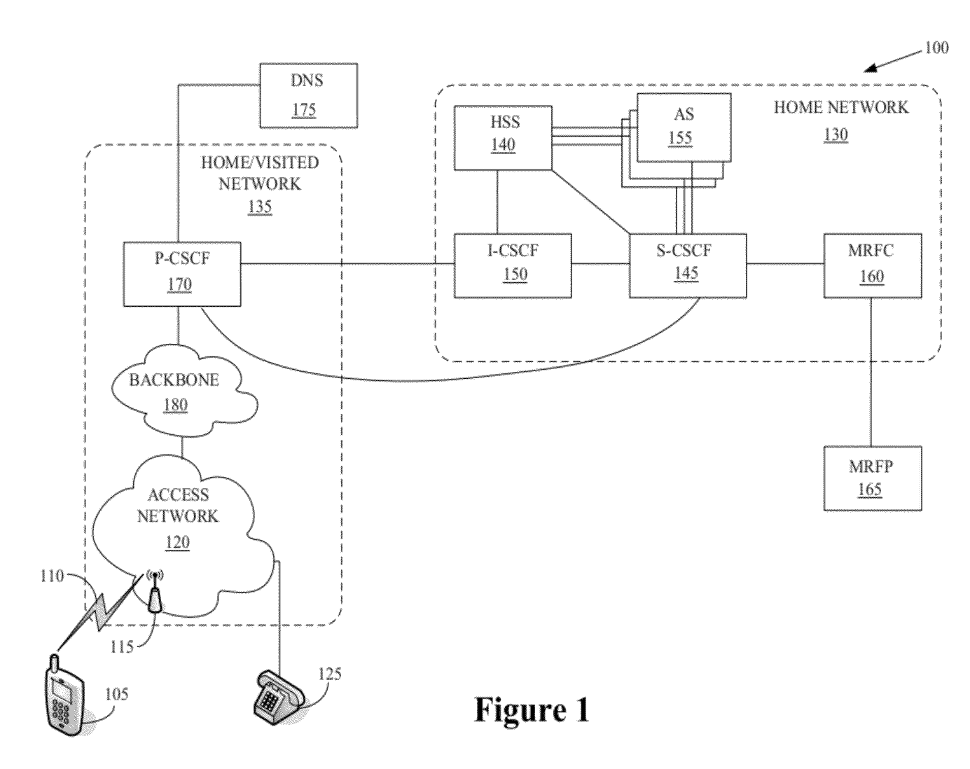

FIG. 1 conceptually illustrates a first exemplary embodiment of a communication system 100. The first exemplary embodiment of the communication system 100 includes elements and/or functionality that operate according to the IP Multimedia Subsystem (IMS) architectural framework for delivering Internet protocol multimedia services. The communication system 100 may therefore be referred to as an IMS network 100. However, persons of ordinary skill in the art having benefit of the present disclosure should appreciate that this embodiment is intended to be illustrative and alternative embodiments of the communication system 100 may operate according to different standards and/or protocols. The communication system 100 provides wireless and/or wireline connectivity. For example, a mobile unit 105 may communicate with the communication system 100 over an air interface 110 to a base station 115 in an access network 120. For another example, a telephone 125 may communicate with the communication system 100 over a wired connection to the access network 120. Other devices such as computers, laptops, smart phones, tablet computers, and the like may also communicate with the communication system 100 over the wired and/or wireless links. These devices may be referred to as access terminals.

Each subscriber has a home network 130 within the communication system 100. The subscriber registers with the home network 130 and then the home network 130 stores subscriber profile information and manages communication sessions for the subscriber. Subscribers may also roam to other networks that are generally referred to as visited or roaming networks. However, it is not necessary for a subscriber to be attached to a visited/roaming network and so the elements in the home/visited network 135 shown in the illustrated embodiment may be found in either the home network 130 or a visited network depending on the location of the access terminal being used by the subscriber.

In the illustrated embodiment, the home network 130 includes a home subscriber server (HSS) 140. The HSS 140 is a master user database that supports the IMS network entities that handle calls. In various embodiments, the HSS 140 may contain subscription-related information for a subscriber (e.g., subscriber profiles), perform authentication and authorization of the user/subscriber, provide information about the subscriber's location, provide IP information associated with the user/subscriber, and the like. The HSS 140 may therefore perform functions that are similar to functions performed by the GSM Home Location Register (HLR) and Authentication Centre (AuC). The HSS 140 may also be referred to as a User Profile Server Function (UPSF).

The home network 130 also includes functionality for performing call/session control. For example, the home network 130 may implement Session Initiation Protocol (SIP) servers or proxy servers such as call session control functions (CSCF) that are used to process SIP signaling packets in the communication system 100. The Session Initiation Protocol (SIP) is an IETF-defined signaling protocol that may be used for controlling multimedia communication sessions such as voice and video calls over IP networks. The SIP protocol can be used for creating, modifying and terminating two-party (unicast) or multiparty (multicast) sessions consisting of one or several media streams. Exemplary functionality supported by SIP for modifying established SIP sessions may include changing addresses or ports, inviting more participants, and adding or deleting media streams. SIP sessions may also be used to support other applications including, but not limited to, video conferencing, streaming multimedia distribution, instant messaging, presence information, file transfer and online games. The SIP protocol and functionality are defined according to various 3GPP standards and/or protocols and in the interest of clarity only those aspects that are relevant to the claimed subject matter will be discussed herein.

In the illustrated embodiment, the home network 130 includes a Serving-CSCF (S-CSCF) 145 that functions as the central node of the signaling plane. The S-CSCF 145 may act as a SIP server and may perform session control. The S-CSCF 145 may communicate with the HSS 140 to access subscriber information. For example, the S-CSCF 145 may use Diameter Cx and Dx interfaces to the HSS 145 to download user profiles and upload user-to-S-CSCF associations. An interrogating CSCF (I-CSCF) 150 may also be included in the home network 130 and used to perform routing services within the home network 130. Persons of ordinary skill in the art having benefit of the present disclosure should appreciate that the S-CSCF 145 and/or I-CSCF 150 may also perform other call session control functions that are not discussed herein in the interest of clarity.

One or more Application servers (AS) 155 may be implemented in the home network 130. Each application server 155 can host and execute services, as well as being configured to interface with the S-CSCF 145, e.g., using SIP messaging. An example of an application server that is being developed in 3GPP is the Voice call continuity function. Depending on the actual service, each AS 155 can operate in SIP proxy mode, SIP UA (user agent) mode or SIP B2BUA mode. In alternative embodiments, other application servers can be located in an external third-party network and used to provide services within the communication system 100. Application servers 155 located in the home network 130 can query the HSS 140 to gather subscriber information, e.g., using messages transmitted over the Diameter Sh or Si interfaces (for a SIP-AS). Application servers that are external to the home network 130 may be able to query the HSS 140 using other interfaces.

Media resource functions provide media related functionality such as media manipulation, playing of tones, announcements, and the like. In the illustrated embodiment, the media resource functions in the communication system 100 includes a media resource function controller 160 located in the home network 130 and the media resource function processor 165. The MRFC 160 is a signaling plane node that interprets information coming from an AS 155 and S-CSCF 145 to control the MRFP 165. The MRFP 165 is a media plane node used to mix, source, and/or process media streams. The MRFP 165 can also manage access right to shared resources.

The communication system 100 may also include a Proxy-CSCF (P-CSCF) 170 to provide a first point of contact for the access terminals in the communication system 100. For example, the P-CSCF 170 may be a SIP proxy that is the first point of contact for the IMS terminals 105, 125. The P-CSCF 170 can be located either in the visited network or in the home network and so the P-CSCF 170 is shown in the home/visited network 135 in FIG. 1. The access terminals 105, 125 may discover the P-CSCF 170 with Dynamic Host Control Protocol (DHCP) using the domain name system (DNS) 175. Alternatively, the access terminals 105, 125 may be configured with the identity of the P-CSCF 170. In the illustrated embodiment, the P-CSCF 170 communicates with the access network 120 over a backbone network 180.

In the illustrated embodiment, the P-CSCF 170 can include a display name in messages (such as SIP Invite messages) that are transmitted from a calling party to a called party. As used herein, the term “display name” will be understood to mean a character string and/or other symbol(s) that can be displayed by an access terminal used by a called party to indicate the identity of the calling party. Multiple display names for each calling party can be stored in subscriber profiles that are downloaded to the P-CSCF 170 upon subscriber registration. The P-CSCF 170 can then select one of the display names in response to receiving a request to initiate a call from the calling party to a called party. For example, different display names can be selected based upon the identity of the called party. The P-CSCF 170 can then include the selected display name in a message that is transmitted towards the called party. Persons of ordinary skill in the art having benefit of the present disclosure should appreciate that alternative embodiments of the communication system 100 may use network entities other than the P-CSCF 170 for storing the display name information and selecting particular display names for transmission in the communication system 100.

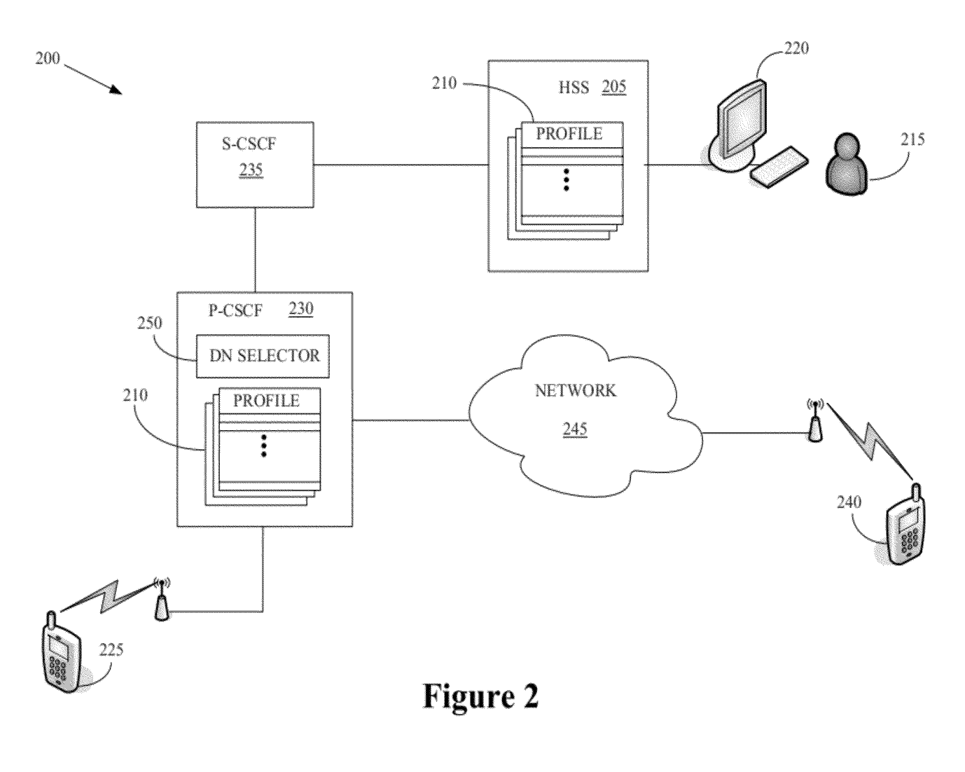

FIG. 2 conceptually illustrates a second exemplary embodiment of a communication system 200. In the illustrated embodiment, the communication system 200 includes a home subscriber server (HSS) 205 that is used to store subscriber profiles 210 for users that are subscribed to the IMS network in the communication system 200. Each subscriber profile 210 includes information such as a public user identity, a private user identity, and the like. The subscriber profiles 210 may also include one or more display names associated with the corresponding user. A display name can be selected from the list of display names and transmitted when the user calls another party. In one embodiment, the subscriber profiles 210 also include conditions or conditional statements that indicate when each of the display names should be selected for transmission to the called party. For example, each display name may be associated with a phone number of the called party or a range of phone numbers for one or more called parties. The display name corresponding to the number or range may then be selected for transmission when the user calls the number or a number in the range of numbers. Alternatively, the conditions may indicate a particular time of day that a display name should be transmitted or when a particular condition should be used to select the display name. The conditions may also indicate that a particular display name should be transmitted (or a particular condition used to select the display name) when the user is at a selected location and/or when the called party is at a selected location. Combinations of these conditions and/or other conditions may also be used to determine which display name to transmit. For example, a user may specify that a first set of conditions should be used to determine the display name during business hours and a second set of conditions should be used to determine the display name outside of business hours.

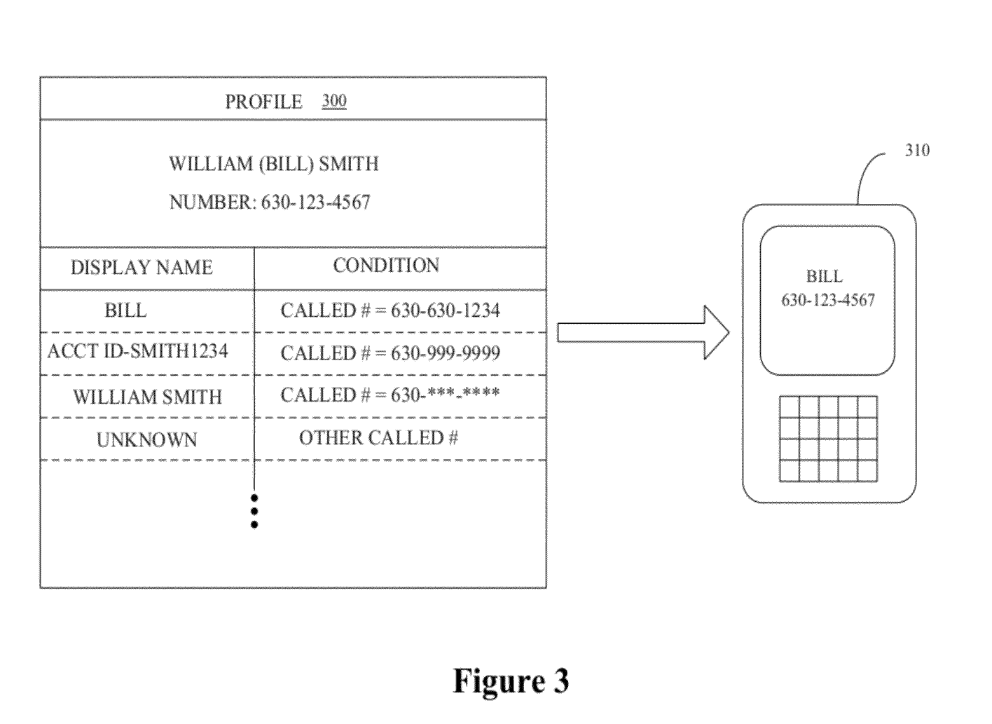

FIG. 3 conceptually illustrates one exemplary embodiment of a subscriber profile 300. In the illustrated embodiment, the subscriber profile 300 includes the subscriber's name (William Smith), the subscriber's nickname (Bill), and the subscriber's phone number (630-123-4567). The subscriber profile 300 also includes a list of display names and conditions that indicate when each display name should be selected. For example, the conditions in the subscriber profile 300 indicate that the subscriber's nickname (Bill) should be selected for calls to the number 630-630-1234, an account identifier (ACCT ID-SMIITH 1234) should be selected for calls to the number 630-999-9999, and the subscriber's name (William Smith) should be selected for all calls to the area code 630. A default display name (Unknown) can be selected for all other calls. In various alternative embodiments, the subscriber profile 300 may also include other information that is not shown in FIG. 3, such as a public identifier, a private identifier, a billing plan, a menu of services that the subscriber has subscribed to, and the like.

In the illustrated embodiment, the profile 300 is used to select a display name for a call to user equipment 310 of a called party. The number of the user equipment 310 is 630-630-1234 and so the network entity, e.g., a P-CSCF associated with the calling party (William Smith), selects the display name Bill and forwards it to the user equipment 310. For example, the display name Bill can be forwarded to the user equipment 310 in a SIP Invite message that invites the called party to establish a SIP session. The display name can then be displayed to the called party by the user equipment 310. In some cases, the number of the calling party can also be displayed, as shown in FIG. 3. The called party may also configure user equipment 310 to provide other signals based on the received display name, such as selected audio and/or video signals. However, persons of ordinary skill in the art having benefit of the present disclosure should appreciate that the display name can be used for other purposes that do not necessarily require using a display device to show the display name to a user. For example, a display name such as an account identifier can be used to locate the calling party's account information in a database maintained by the called party. The called party may also use the display name to direct the call to the appropriate service, operator, customer service professional, switchboard, and the like.

Referring back to FIG. 2, individual subscribers or users 215 can establish and/or configure their subscriber profiles 210 using an interface to the HSS 205. For example, the user 215 can log into the HSS 205 using an access terminal 220. The identity of the user 215 can be confirmed/authenticated prior to allowing the user 215 to establish and/or modify a subscriber profile 210, e.g., by requiring the user 215 to supply a username and password or using some other authentication agreement or procedure. The user 215 can establish, configure, and/or modify their subscriber profile 210 so that particularly relevant display names are transmitted to different called parties. The display name could be a name, a nickname, or an identifier that has been assigned to the user by a service provided by the called party. For example, when the user 215 calls a hospital number to make a doctor appointment, the user may want to display his/her medical record/profile ID as the display name to speed processing of the request. Similarly, when the user 215 calls a utility service provider, the user 215 may want to display his/her utility account ID as the display name to speed the processing by allowing the utility service provider to look up the user's account in a database. When the user 215 calls family members or friends, the user 215 may want to use his/her nickname as the display name and when the user 215 calls a limo service, the user 215 may want to send his/her phone number so that the automated reservation service can derive the pick up or destination address. Many credit card companies use the caller ID as one of the numbers used to verify the identity of the card holder. In some cases, the caller may be routed to an operator if the caller ID is not received and so the user 215 may experience delays when the caller ID is not provided. The user 215 may therefore configure the profile 210 so that the display name includes the caller ID when calls are placed to a credit card company.

In one embodiment, service providers that offer the flexible display name (FDN) service may allow the user 215 to configure the subscriber profiles 210 using a web interface. The user 215 may navigate to the service provider's website and open a graphical user interface (GUI) provided by the flexible display name service. Once the user 215 successfully logs in to the service via the GUI, the GUI can prompt the user 215 to enter flexible display name data. For example, the GUI may prompt the user 215 to enter display name data in the format:
User's PUID
Display name 1, Display name 1 condition(s)
Display name 2, Display name 2 condition(s)
Display name n, Display name 3 condition(s)
   In various embodiments, the display name condition can be a specific phone number or public user identifier (PUID), leading digits of a phone number, a specific fully qualified domain name (FQDN), a domain of a FQDN, or other identifier or range of identifiers. The display name condition may also indicate ranges, groups, default numbers, or negative/alternative conditions such as “any number, PUID, FQDN, Domain that is not listed in the FDN data.” The display name conditions may also indicate particular times of day for the conditions to be applied. In some embodiments, the conditions may only be applied when the called party and/or the calling party are at specific locations or within certain areas, buildings, complexes, campuses, and the like. The service provider may then store the new or modified/reconfigured profile 210 in the HSS 205.

The HSS 205 can forward or transmit subscriber profile information to various network entities. In one embodiment, when an access terminal 225 registers with a network entity such as a P-CSCF 230, the HSS 205 transmits a copy of a subscriber profile 210 associated with the user 215 of the access terminal 225 to a S-CSCF 235. For example, in an IMS network, when the HSS 205 receives a Cx SAR (Server-Assignment-Request), the HSS 205 can transmit a Cx SAA (Server-Assignment-Answer) to the S-CSCF 235. The Cx SAA includes the subscriber's FDN data (which includes multiple display names and conditions for their application instead of a single value of the DisplayName that is always transmitted) in the user's IMS service profile. The S-CSCF 235 can then forward a copy of the subscriber profile 210 to the P-CSCF 230. Copies of the subscriber profiles 210 for each registered user 215 may therefore be stored at the P-CSCF 230 while the users remain registered.

The P-CSCF 230 can use the stored subscriber profile information to select display names that are transmitted to called parties when the access terminal 225 (the calling party) initiates a call to an access terminal 240 (the called party) over the network 245. In the illustrated embodiment, the P-CSCF 230 includes display name selector functionality 250 that can access the subscriber profiles 210 and other information to evaluate the conditions defined in the subscriber profiles 210. The display name selector functionality 250 can be implemented in hardware, firmware, software, or any combination thereof. The display name selector functionality 250 can then choose the display name that satisfies the conditions specified in the profile 210. For example, when the calling party 225 initiates a SIP INVITE or SIP MESSAGE, the P-CSCF 230 can check the terminating number/address of the called party 240. Based on the display names and conditions listed in user's FDN, the P-CSCF 230 can select an applicable display name and include the selected display name in the SIP INVITE or SIP MESSAGE.

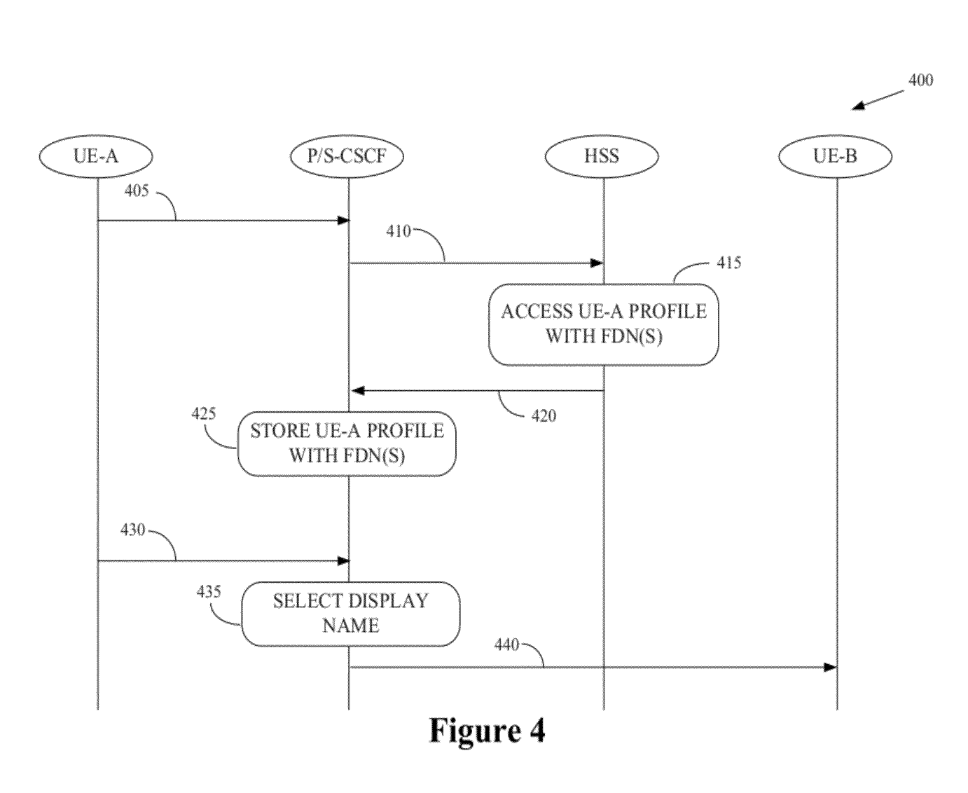

FIG. 4 conceptually illustrates one exemplary embodiment of a method 400 of selecting one of a plurality of display names. In the illustrated embodiment, a calling party (UE-A) registers with the network, e.g. by transmitting a SIP invite to the call session control functionality (P/S-CSCF) of the network (at 405). The call session control functionality then queries the home subscriber server (HSS) and requests a subscriber profile for the registered calling party (at 410). For example, in an IMS network, the call session control functionality may transmit a Diameter Cx MAR/A message to the home subscriber server to request the subscriber profile. The home subscriber server can then access (at 415) the service profile for the calling party and return the requested profile (at 420) including the flexible domain name information. Exemplary FDN information includes different values of the display name and the conditions under which the different display names should be selected for transmission to the called party. For example, the home subscriber server may return the requested FDN information in a Diameter Cx SAR/A message. The call session control functionality may then store (at 425) the calling party's profile.

In the illustrated embodiment, the calling party initiates a call to the called party (UE-B) by transmitting a message to the call session control functionality (at 430). For example, the calling party may transmit a SIP Invite message to invite the called party to establish a SIP session over the IMS network. In response to receiving the initiation message, the call session control functionality chooses (at 435) a display name for transmission to the called party. The selection can be performed on the basis of information identifying the called party, the time of day, locations of the calling party and/or the called party, and the like. For example, the call session control functionality may evaluate the conditions associated with the different display names and select the display name that satisfies its associated condition. The call session control functionality may then populate the invitation message with the selected display name and transmit the message toward the called party (at 440). The called party may use the received display name, e.g., to display this information to the called party or to identify the calling party to operators or automated services provided by the called party.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
selecting, at a network entity, one of a plurality of display names for a calling party in response to receiving a request to initiate a call from the calling party to a called party; and
transmitting a message from the network entity towards the called party, wherein the message includes said one of the plurality of display names for the calling party.

2. The method of claim 1, wherein selecting said one of the plurality of display names comprises selecting said one of the plurality of display names based upon a corresponding plurality of predetermined conditions indicating the conditions under which each of the plurality of display names are to be selected.

3. The method of claim 2, wherein each of the plurality of predetermined conditions indicates at least one number of a called party that receives a corresponding one of the plurality of display names.

4. The method of claim 2, wherein each of the plurality of predetermined conditions indicates that a corresponding one of the plurality of display names is to be provided at a predetermined time, when the calling party is at a predetermined location, or when the called party is at a predetermined location.

5. The method of claim 1, wherein selecting said one of the plurality of display names comprises selecting said one of the plurality of display names that includes an identifier assigned to the calling party by a service associated with the called party.

6. The method of claim 1, comprising transmitting a request for a service profile for the calling party from the network entity to a home subscriber server in response to the calling party registering with the network entity.

7. The method of claim 6, comprising receiving the service profile for the calling party at the network entity, and wherein selecting said one of the plurality of display names comprises selecting said one of the plurality of display names from the plurality of display names included in the service profile.

8. A method, comprising:
storing at least one subscriber profile at a home subscriber server, wherein said at least one subscriber profile comprises a plurality of display names for a subscriber associated with the subscriber profile, wherein each of the plurality of display names can be transmitted to a called party when a subscriber initiates a call to the called party; and
transmitting said at least one subscriber profile from the home subscriber server to a network entity in response to the subscriber registering with the network entity.

9. The method of claim 8, wherein storing said one subscriber profile comprises storing the plurality of display names for the subscriber and a corresponding plurality of predetermined conditions indicating the conditions under which each of the plurality of display names are to be selected for transmission to the called party.

10. The method of claim 9, wherein each of the plurality of predetermined conditions indicates at least one number of a called party that receives a corresponding one of the plurality of display names.

11. The method of claim 9, wherein each of the plurality of predetermined conditions indicates that a corresponding one of the plurality of display names is to be provided at a predetermined time, when the calling party is at a predetermined location, or when the called party is at a predetermined location.

12. The method of claim 9, wherein storing the plurality of display names comprises storing at least one display name that includes an identifier assigned to the subscriber by a service associated with the called party.

13. A method, comprising:
storing, at a network entity, a plurality of display names for a calling party in response to receiving a request to initiate a call from the calling party to a called party; and
transmitting a message from the network entity towards the called party, wherein the message includes a selected one of the plurality of display names for the calling party.

14. The method of claim 13, comprising selecting said selected one of the plurality of display names based upon a corresponding plurality of predetermined conditions indicating the conditions under which each of the plurality of display names are to be selected.

15. The method of claim 14, wherein each of the plurality of predetermined conditions indicates at least one number of a called party that receives a corresponding one of the plurality of display names.

16. The method of claim 14, wherein each of the plurality of predetermined conditions indicates that a corresponding one of the plurality of display names is to be provided at a predetermined time, when the calling party is at a predetermined location, or when the called party is at a predetermined location.

17. The method of claim 14, wherein selecting said one of the plurality of display names comprises selecting said one of the plurality of display names that includes an identifier assigned to the calling party by a service associated with the called party.

18. The method of claim 14, comprising transmitting a request for a service profile for the calling party from the network entity to a home subscriber server in response to the calling party registering with the network entity, wherein the service profile indicates the plurality of display names and the corresponding plurality of predetermined conditions.

19. The method of claim 18, comprising receiving the service profile for the calling party at the network entity, and wherein selecting said one of the plurality of display names comprises selecting said one of the plurality of display names from the plurality of display names included in the service profile.
